(19) United States
(12) Patent Application Publication
(10) Pub. No.: US 2015/0354452 A1
(43) Pub. Date: Dec. 10, 2015

(54) STARTER DEVICE FOR ROCKET MOTOR TURBOPUMP

(71) Applicant: AIRBUS DEFENCE AND SPACE SAS, Les Mureaux (FR)

(72) Inventors: Jean-Philippe DUTHEIL, Martignas-sur-Jalles (FR); Pierre VINET, Villers Saint Frederic (FR)

(73) Assignee: AIRBUS DEFENCE AND SPACE SAS, Les Mureaux (FR)

(21) Appl. No.: 14/761,401

(22) PCT Filed: Jan. 16, 2014
(86) PCT No.: PCT/EP2014/050838

§ 371 Date: Jul. 16, 2015

(30) Foreign Application Priority Data
Jan. 18, 2013 (FR) 1350456

(51) Int. Cl. F02C 6/08; F02K 9/46; F02K 9/78; F02C 7/32

(52) U.S. Cl. CPC F02C 6/08; F02C 7/32; F02K 9/46; F02K 9/78

(57) ABSTRACT

The subject of the invention is a device for starting a turbopump of a rocket motor of an aircraft including a turbine engine for propelling the aircraft and a rocket motor, which includes a pneumatic supply of compressed air to a turbine of the turbopump, this compressed air being tapped from a tapping on a compressor stage of the aircraft propulsion turbine engine upstream of the combustion chamber of the turbine engine. It applies notably to an aircraft of the space airplane type.

### CROSS REFERENCE TO RELATED APPLICATIONS

This application is the National Stage of International Application No. PCT/EP2014/050838, having an International Filing Date of 16 Jan. 2014, which designated the United States of America, and which International Application was published under PCT Article 21 (s) as WO Publication 2014/111485 A1, and which claims priority from, and the benefit of French Application No. 1350456, filed 18 Jan. 2013, the disclosures of which are incorporated herein by reference in their entireties.

### BACKGROUND

1. Field

The presently disclosed embodiment concerns a device for starting a rocket motor turbopump in an aircraft, for example a space plane including a double (turbine engine and rocket motor) propulsion system, the turbine engine notably being a turbojet.

Such a space plane may be a single-stage vehicle, meaning that the two propulsion systems are in the same stage throughout the flight of the space plane. Or it may be a two-stage vehicle, in which the propulsion systems are in two distinct stages that are joined at the time of take-off but which separate during flight.

2. Brief Description of Related Developments

In rocket motor aircraft, the rocket motors are generally fed with propellants by means of turbopumps.

A turbopump is a pump driven by a turbine, that is to say a rotary device driven by a fluid in movement.

The turbopumps serve to pump fluids (the propellants) from the tanks to the combustion chambers of the rocket motor.

In the case of spacecraft launch vehicles, the turbopumps are started before the take-off of the launch vehicle, after which they continue to function throughout the thrust phase of the rocket motor. The turbopumps of the higher stages are started during a phase of starting the rocket motors of these higher stages coinciding with the separation of the stages.

One technique for starting the turbopumps consists in using a gas generator in which a small fraction of the propellants feeding the rocket motor or motors is burned, this gas generator driving the turbine of the turbopumps.

The turbopumps can also be started with the aid of a starter including a block of solid propellant the combustion of which supplies hot gases driving the rotation of the turbine of the turbopump, the turbopump then aspirating the propellants intended to feed the rocket motor.

The turbopumps can also be started by means of cold gases stored at high pressure in a dedicated tank carried by the vehicle.

The turbopump starting devices supply gases with sufficient energy to start rotation of the turbines that in turn drive the pumps feeding the rocket motor with propellants.

Document U.S. Pat. No. 2,531,761 describes the use of hot gases coming from the combustion chamber of a turbojet in the context of an atmosphere aircraft including a turbine engine and a rocket motor for increasing the thrust or for flight at very high altitudes.

These hot gases are introduced into the turbine of a turbopump via a first feed circuit and a combustion chamber of a gas generator using the propellants feeding the rocket motor is connected to a second feed circuit of this turbine.

With the exception of starting devices using cold gases stored at high pressure, the prior art devices using hot gases subject the turbine to a severe thermal shock when it starts.

For example, the temperature of the gases from a pyrotechnic starter is at least approximately 1300° C. and the hot gases bled from the combustion chamber of the turbojet in the document U.S. Pat. No. 2,531,761 is approximately 1200° C.

For its part the pressurized storage device is heavy and bulky.

Finally, for a space plane type aircraft intended to carry out numerous flights, the cost of use criterion is primordial. This means that it is necessary to limit maintenance and replacement of parts between two flights; whence the necessity of minimizing the stresses on the various equipment units to increase their service life.

In this context it is therefore necessary to reduce the thermal shocks to which the turbopumps are subjected and therefore to reduce the temperatures to which they are subjected and to heat them more gradually.

### SUMMARY

The presently disclosed embodiment proposes a device for starting a turbopump of a rocket motor of an aircraft including a turbine engine for propelling the aircraft and a rocket motor, characterized in that it includes a pneumatic supply for starting a turbine of the turbopump via a circuit for injection of compressed air bled by means of a tapping from a compressor stage of the turbine engine for propelling the aircraft on the upstream side of the combustion chamber of said turbine engine.

Compared to the prior art, the device of the presently disclosed embodiment that uses unburned gases makes it possible to avoid subjecting the turbine of the turbopump to a thermal shock when it starts from cold.

The device of the presently disclosed embodiment heats the turbine much less than the prior art devices because it uses compressed air at a maximum temperature of approximately 600° C. It furthermore remains relatively compact and adds relatively little mass to the propulsion system of the aircraft.

Moreover, the members controlling the gas flow feeding the turbine are not subjected to high temperatures, unlike the prior art devices.

The device advantageously comprises a combustion chamber of a generator of gas for driving rotation of the turbine of the turbopump, said chamber being fed with liquid propellants when the rocket motor is operating.

In accordance with one particular aspect, the circuit for injection of compressed air into the turbine is adapted to fill said chamber with said compressed air so as to inject oxygen gas with at least one liquid propellant or in a mixture of liquid propellants during the phase of ignition of the gas generator so as to improve starting the combustion of these liquid propellants.

In accordance with one advantageous aspect, the device further comprises means for cooling the bled air.

In accordance with one particular aspect, the cooling means include a heat exchanger cooled with air from outside the aircraft.

In accordance with an alternative or complementary aspect, the cooling means use all or part of a line for feeding the rocket motor with cryogenic propellants.

The pneumatic supply of the turbine of the turbopump is advantageously equipped with valves, calibration means and check valves adapted for fast and controlled starting of rotation of the turbine from the tapping.

The disclosed embodiment further concerns a system for propulsion of an aircraft including at least one turbine engine and at least one rocket motor that includes a device according to the disclosed embodiment for starting a turbopump of the rocket motor and the disclosed embodiment applies in particular to a space plane or a hypersonic aircraft including such a propulsion system.

The disclosed embodiment finally concerns a method of starting a rocket motor turbopump by means of a device of the disclosed embodiment, including a first step of injection of compressed air into a turbine of the turbopump and then a step of injection of propellants into a combustion chamber of a generator of gas for driving the turbopump thanks to the driving of the turbine by the compressed air.

The injection of air into the turbine is advantageously stopped by means of a valve when the pressure in the gas generator exceeds the setting of the valve.

### BRIEF DESCRIPTION OF THE DRAWINGS

Other features and advantages of the disclosed embodiment will become apparent on reading the following description with reference to the drawings, which represent:

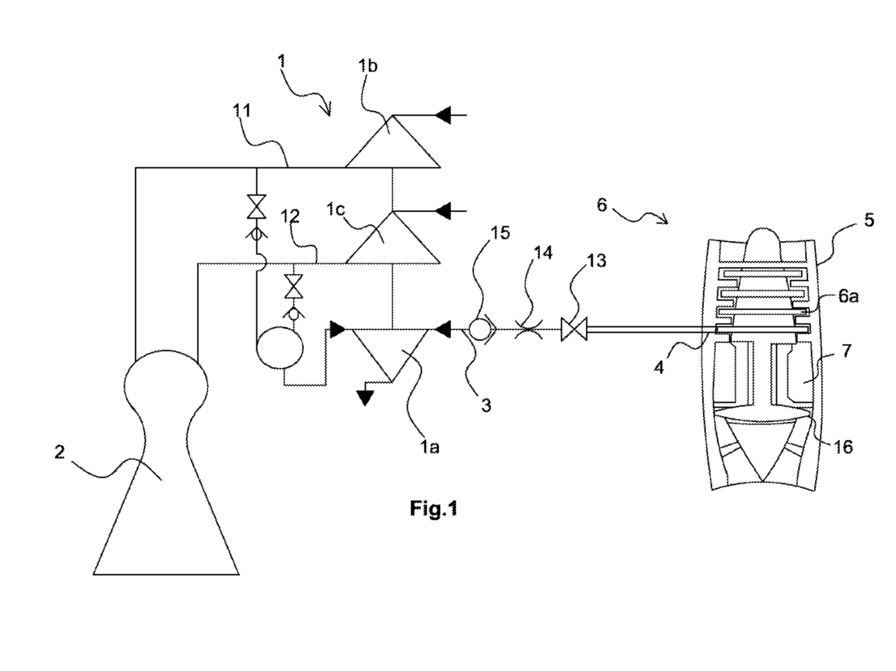

in FIG. 1: a diagrammatic view of a device in accordance with the principle of the disclosed embodiment;

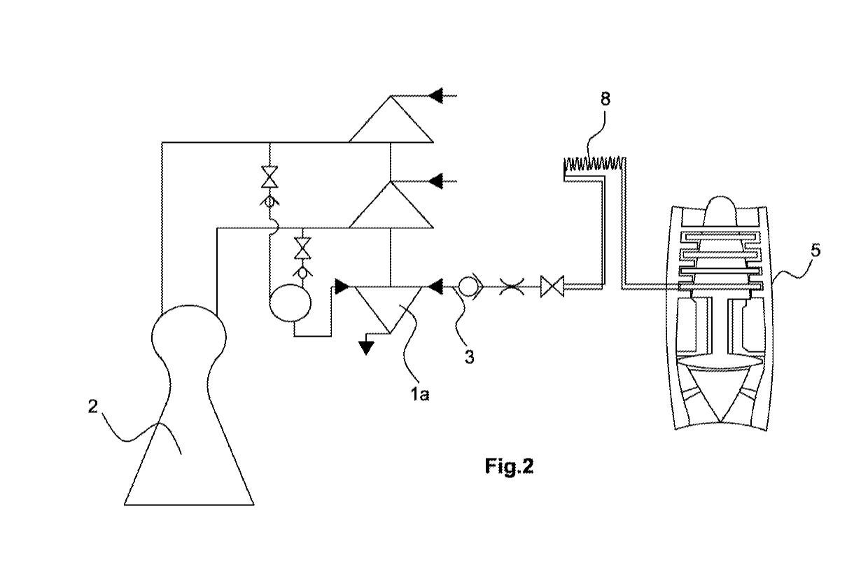

in FIG. 2: a diagrammatic view of a device in accordance with a first aspect of the disclosed embodiment with an air exchanger;

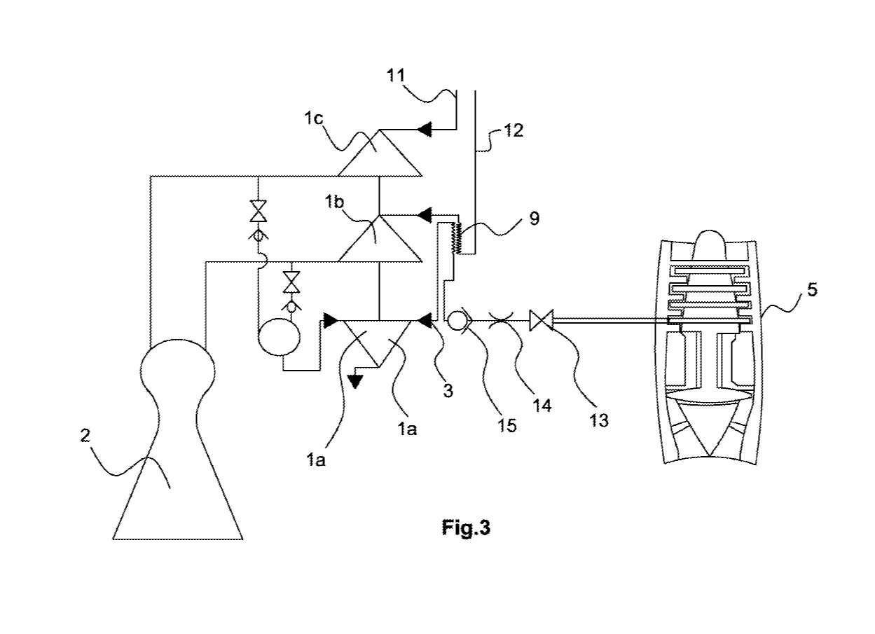

in FIG. 3: a diagrammatic view of a device in accordance with a second aspect of the disclosed embodiment with a liquid exchanger;

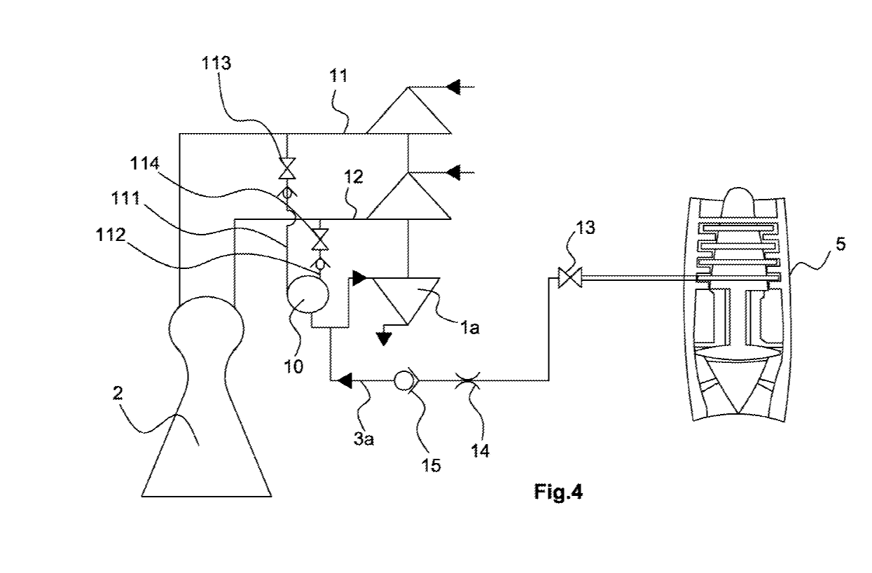

in FIG. 4: a diagrammatic view of a device in accordance with a third aspect of the disclosed embodiment fed via a gas generator chamber.

### DETAILED DESCRIPTION

The disclosed embodiment concerns a motor system of a space plane including two distinct propulsion systems: one or more turbojets for atmosphere phase flight and a rocket propulsion system using one or more liquid-fuelled rocket motors with turbopumps for space flight, such as suborbital flight.

FIG. 1 represents diagrammatically such a propulsion system including a turbojet 5 and a rocket motor 2 between which is a turbopump 1 for feeding the rocket motor in accordance with the disclosed embodiment.

For simplicity, the known tanks and ancillary systems of the rocket motor and the thermal engine of the aircraft are not represented.

Here the turbopump is a turbopump including a turbine 1a driving two pumps 1b, 1c which feed the rocket motor with liquid propellants 11, 12 under pressure, for example a fuel and an oxidizer pumped from tanks that are classic in the art and are not represented.

The turbine engine 5 propelling the aircraft, which is of the turbojet type for example, includes in the conventional manner a plurality of compressor stages 6, a combustion chamber 7 and a turbine 16 subjected to the outlet flow from the combustion chamber and driving the compressors 6.

The device of the disclosed embodiment bleeds air compressed by the compressors 6 to feed a fluid circuit of the turbine 1a of the turbopump 1 of the rocket motor or motors.

This feed circuit includes a tapping 4 in a compressor stage 6a of the turbine engine 5.

The compressor stage from which air is bled is chosen to enable bleeding that does degrade the operation of the turbine engine and moreover is carried out in a stage yielding a gas temperature and a pressure compatible with the operation of the turbine 1a of the turbopump 1. The air is bled in a compressor stage supplying a medium pressure, for example a pressure of the order of 10 bar.

The circuit 3 connecting the turbine 1a to the tapping 4 is equipped with a valve 13 for opening or closing the compressed air feed to the turbine.

The valve 13 is opened to start rotation of the turbine 1a and then closed once the turbopump has started and is being fed with some of the propellants of the rocket motor.

The circuit further includes fluid calibration means 14 and a check valve 15.

The combination of these means enables fast and controlled starting of feeding of the turbine from the pressurized air bleed tapping 4 on the upstream side of the combustion chamber 7 of the turbojet.

The possibility of choosing the stage of the compressor for bleeding the air makes it possible to adjust the temperature of the compressed air.

The possibility of limiting the temperature of the gases reaching the turbine 1a during the transient phase of starting rotation of the turbine is a key element for improving the service life of the turbine.

In fact, during this starting phase the turbine is subjected to a steep thermal gradient from ambient temperature up to the temperature of the hot gases produced by combustion of the propellants.

In FIGS. 2 and 3, the temperature of the compressed air fed to the turbine 1a of the turbopump is adjusted by an exchanger 8, 9 on the feed line of the turbine.

In the FIG. 2 example the exchanger is an air/air exchanger 8 situated at the level of an external air intake so that the exterior air through which the aircraft is passing cools the pressurized gases feeding the turbine 1a.

In the FIG. 3 example the exchanger 9 is an air/liquid exchanger situated in a circuit feeding the pump 1b with propellant 12 that is particularly advantageous if the propellant is at a cryogenic temperature.

It is notably possible either to use the cryogenic line as a cold source or to use all or part of what is circulating in this cryogenic line as a cold source in the cold circuit of an exchanger.

The circuit of the turbopumps includes a combustion chamber 10 of a gas generator in communication with the turbine of the turbopump.

This gas generator is fed with the cryogenic propellants 11, 12 pumped by the pumps 1b, 1c of the turbopump that are ignited in the combustion chamber by ignition means known in themselves.

Compressed air is injected in the turbine or its injection casing travels to the combustion chamber of the gas generator because of the absence of any valve between the turbine and this combustion chamber, which also contains air, which facilitates igniting the propellants.

In this case the air feed circuit serves to inject oxygen gas from the air bled from the turbojet during the phase of starting the gas generator feeding the turbine, which is of a kind that improves this starting phase.

In fact, in the case of cryotechnical propellants, starting in the liquid phase is not easy to control. This is why igniting the liquid fuel with oxygen from the air can render the phase of starting the gas generator and therefore of starting the rocket motor more reliable.

Starting the rocket motor therefore includes a first step of injection of compressed air into a turbine of the turbopump and then a step of injection of propellants into a combustion chamber 10 of a generator for generating gases for driving the turbopump thanks to the driving of the turbine by the compressed air. Once the turbopump has been started, the injection of air into the turbine is stopped by means of a valve 15 when the pressure in the gas generator exceeds the setting of the valve.

This is therefore an advantage of the disclosed embodiment, which bleeds air from a compressor outlet rather than in or after the combustion chamber of the turbojet where there is no longer any oxygen available as oxidizer.

In such an arrangement, the sequence begins by the turbine 1a starting rotation using air injected from the compressor 6 while the propellant feed lines 111, 112 are closed by the valves 113, 114. The liquid fuel pumped by the turbopump (for example the propellant 12) is then injected into the chamber 10 by opening the valve 114 and this fuel is ignited with oxygen from the compressed air by means of an ignition device such as a sparkplug. The oxidizer 11 is then injected by opening the valve 113. When combustion has been established, the air feed is shut off by closing the valve 13, which terminates the rocket motor starting phase.

Note that when the vehicle is a two-stage space plane, it is simply necessary to provide in the compressed air line between the turbojet and the turbine an automatic disconnection device that enables separation of this line at the time of stage separation.

The device of the disclosed embodiment therefore injects oxygen gas with a propellant or in a mixture of liquid propellants during the phase of starting the gas generator for improved starting of the combustion of the liquid propellants of the gas generator.

Another possibility offered by this system is to operate the rocket motor in reduced thrust mode by actuating the turbine by means of combustion of a limited flow of liquid oxidizer 12 of the rocket propulsion system with air coming from the turbojet.

This mode of operation, which is restricted to the phase of aeronautical atmospheric flight with the turbojet or turbojets operating, can address a possible requirement of the vehicle for additional thrust.

The disclosed embodiment notably applies to a space plane with a double (turbojet and rocket motor) propulsion system or a hypersonic aircraft with a double (turbojet and rocket motor) propulsion system.

What is claimed is:

1. A device for starting a turbopump of a rocket motor of an aircraft including a turbine engine for propelling the aircraft and a rocket motor, the device comprising a pneumatic supply for starting a turbine of the turbopump via a circuit for injection of compressed air bled by means of a tapping from a compressor stage of the turbine engine for propelling the aircraft on the upstream side of the combustion chamber of said turbine engine.

2. The device as claimed in claim 1, further comprising a combustion chamber of a generator of gas for driving rotation of the turbine of the turbopump, said chamber being fed with liquid propellants when the rocket motor is operating.

3. The device as claimed in claim 2, wherein the circuit for injection of compressed air into the turbine is adapted to fill said chamber with said compressed air so as to inject oxygen gas with at least one liquid propellant or in a mixture of liquid propellants during the phase of ignition of the gas generator for improved starting of the combustion of these liquid propellants.

4. The device as claimed in claim 1 further comprising means for cooling the bled air.

5. The device as claimed in claim 4 wherein the cooling means comprises a heat exchanger cooled by air from outside the aircraft.

6. The device as claimed in claim 4 wherein the cooling means use all or part of a line for feeding the rocket motor with cryogenic propellants.

7. The device as claimed in claim 1 wherein the circuit for injection of compressed air for pneumatic supply of the turbine of the turbopump is equipped with a valve, calibration means and a check valve adapted to produce fast and controlled rotation of the turbine from the tapping.

8. A system for propulsion of an aircraft including at least one propulsion turbine engine and at least one rocket motor, the system comprises a device according to claim 1 for starting a turbopump of the rocket motor.

9. A space plane comprising a propulsion system as claimed in claim 8.

10. A hypersonic aircraft comprising a propulsion system as claimed in claim 8.

11. A method of starting a rocket motor turbopump by means of a device as claimed in claim 1, the method comprising a first step of injection of compressed air into a turbine of the turbopump and then a step of injection of propellants into a combustion chamber of a generator of gas for driving the turbopump thanks to the driving of the turbine by the compressed air.

12. The method as claimed in claim 11, wherein the injection of air into the turbine is stopped by means of a valve when the pressure in the gas generator exceeds the setting of the valve.
